(19) United States
(12) Patent Application Publication
(10) Pub. No.: US 2026/0244981 A1
(43) Pub. Date: Aug. 20, 2026

(54) DISTRIBUTED TRAINING OF MACHINE LEARNING MODELS USING CONTAINER ORCHETRATION SYSTEM

(71) Applicant: S&P Global Inc., New York, NY (US)

(72) Inventors: Mikhail G. Arov, Lincoln, CA (US); Dogacan Colak, Long Island City, NY (US); Sathvik Birudavolu, Somerville, MA (US)

(21) Appl. No.: 19/057,619

(22) Filed: Feb. 19, 2025

(51) Int. Cl. G06N 20/00; G06F 11/07

(52) U.S. Cl. CPC G06N 20/00; G06F 11/0709; G06F 11/0793

(57) ABSTRACT

An illustrative embodiment provides a computer-implemented method. The method comprises using a processor set to create a headless service and a number of pods for a container orchestration system. Each pod from the number of pods comprises a number of containers for performing tasks. The processor set transfers a set of training data from a cloud object storage service to the number of pods from the container orchestration system. The processor set trains a machine learning model using the set of training data. The machine learning model is trained in a distributed manner using the headless service and the number of pods for the container orchestration system, and the container orchestration system divides training task for the machine learning model into a number of portions of the training task and each pod from the number of pods performs a portion of the training task to train the machine learning model.

### BACKGROUND INFORMATION

### 1. Field

The present disclosure relates generally to training machine learning models in a distributed manner using container orchestration system.

### 2. Background

Machine learning models are mathematical representations of patterns and relationships within data. Machine learning models are designed to make predictions or decisions without explicit programming. Unlike traditional software that follows pre-defined rules, machine learning models learn from historical data and refine their understanding of data through training.

A machine learning model has a set of parameters and algorithms that transform input data into meaningful output. Machine learning models are trained on datasets that contain examples of the problems it aims to solve. In this case, machine learning models rely on different types of algorithms depending on the problem they address. For example, linear regression and decision trees are commonly used for predictive modelling, while neural networks can be configured in classification tasks.

### SUMMARY

An illustrative embodiment provides a computer-implemented method. The method comprises using a processor set to create a headless service and a number of pods for a container orchestration system. Each pod from the number of pods comprises a number of containers for performing tasks. The processor set transfers a set of training data from a cloud object storage service to the number of pods from the container orchestration system. The processor set trains a machine learning model using the set of training data. The machine learning model is trained in a distributed manner using the headless service and the number of pods for the container orchestration system, and the container orchestration system divides training task for the machine learning model into a number of portions of the training task and each pod from the number of pods performs a portion of the training task to train the machine learning model.

Another illustrative embodiment provides a computer system. The system comprises a processor set, a set of one or more computer-readable storage media, and program instructions stored on the set of one or more storage media to cause the processor set to perform operations comprising creating a headless service and a number of pods for a container orchestration system, where each pod from the number of pods comprises a number of containers for performing tasks; transferring a set of training data from a cloud object storage service to the number of pods from the container orchestration system; and training a machine learning model using the set of training data, where the machine learning model is trained in a distributed manner using the headless service and the number of pods for the container orchestration system, and where the container orchestration system divides training task for the machine learning model into a number of portions of the training task and each pod from the number of pods performs a portion of the training task to train the machine learning model.

Another illustrative embodiment provides a computer program product. The computer program product comprises a set of one or more computer-readable storage media, and program instructions stored in the set of one or more storage media to perform operations comprising using a processor set to create a headless service and a number of pods for a container orchestration system, where each pod from the number of pods comprises a number of containers for performing tasks; to transfer a set of training data from a cloud object storage service to the number of pods from the container orchestration system; and to train a machine learning model using the set of training data, where the machine learning model is trained in a distributed manner using the headless service and the number of pods for the container orchestration system, and where the container orchestration system divides training task for the machine learning model into a number of portions of the training task and each pod from the number of pods performs a portion of the training task to train the machine learning model.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a pictorial representation of a network of data processing systems in which illustrative embodiments may be implemented;

FIG. 2 depicts a block diagram of a model management environment in accordance with an illustrative embodiment;

FIG. 3 depicts an exemplary architecture for training machine learning models in accordance with an illustrative embodiment;

FIG. 4 depicts a flowchart illustrating a process for training machine learning models in accordance with an illustrative embodiment;

FIG. 5 depicts a flowchart illustrating a process for training a machine learning model in accordance with an illustrative embodiment;

FIG. 6 depicts a flowchart illustrating a process for recovering progress for the training task of a machine learning model in accordance with an illustrative embodiment;

FIG. 7 depicts a flowchart illustrating a process for selecting a head pod to perform a portion of the training task in accordance with an illustrative embodiment; and

FIG. 8 is a block diagram of a data processing system in accordance with an illustrative embodiment.

### DETAILED DESCRIPTION

The illustrative embodiments recognize and take into account a number of considerations. For example, the illustrative embodiments recognize and take into account that training machine learning models at scale requires a robust infrastructure to handle large datasets, complex computations, and resource-intensive processes.

The illustrative embodiments recognize and take into account that as neural networks grow in size and complexity, their memory requirements increase significantly and create an upper bound on vertical scaling efforts.

The illustrative embodiments also recognize and take into account that container orchestration systems provide a helpful solution by automating the deployment, scaling, and management of trainings for machine learning models across distributed computing environments.

Thus, illustrative embodiments of the present invention provide a computer implemented method, computer system, and computer program product for training machine learning models using an improved architecture. The method comprises using a processor set to create a headless service and a number of pods for a container orchestration system. Each pod from the number of pods comprises a number of containers for performing tasks. The processor set transfers a set of training data from a cloud object storage service to the number of pods from the container orchestration system. The processor set trains a machine learning model using the set of training data. The machine learning model is trained in a distributed manner using the headless service and the number of pods for the container orchestration system, and the container orchestration system divides training task for the machine learning model into a number of portions of the training task and each pod from the number of pods performs a portion of the training task to train the machine learning model.

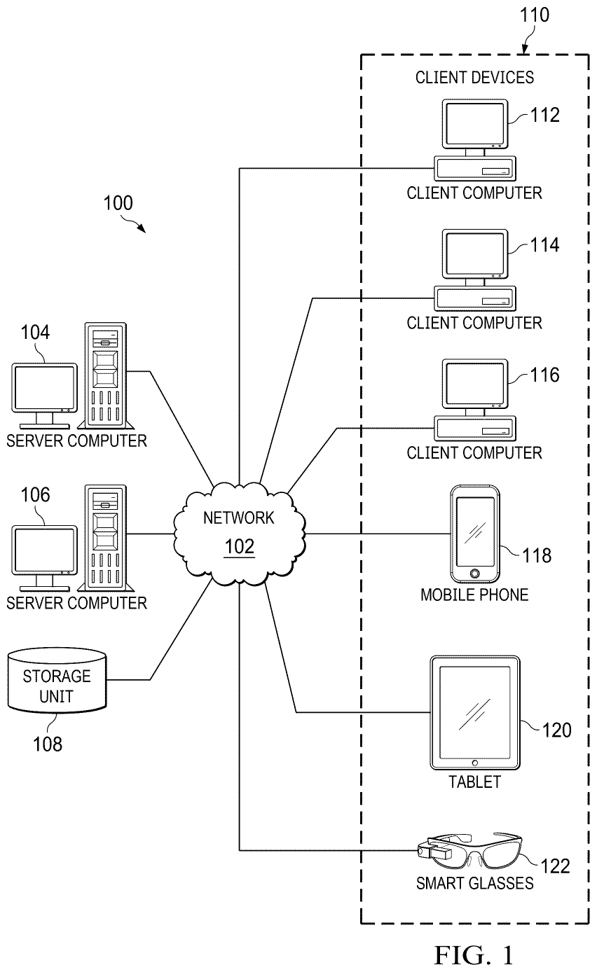

With reference to FIG. 1, a pictorial representation of a network of data processing systems is depicted in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 might include connections, such as wire, wireless communication links, or fiber optic cables.

In the depicted example, server computer 104 and server computer 106 connect to network 102 along with storage unit 108. In addition, client devices 110 connect to network 102. In the depicted example, server computer 104 provides information, such as boot files, operating system images, and applications to client devices 110. Client devices 110 can be, for example, computers, workstations, or network computers. As depicted, client devices 110 include client computers 112, 114, and 116. Client devices 110 can also include other types of client devices such as mobile phone 118, tablet 120, and smart glasses 122.

In this illustrative example, server computer 104, server computer 106, storage unit 108, and client devices 110 are network devices that connect to network 102 in which network 102 is the communications media for these network devices. Some or all of client devices 110 may form an Internet of things (IoT) in which these physical devices can connect to network 102 and exchange information with each other over network 102.

Client devices 110 are clients to server computer 104 in this example. Network data processing system 100 may include additional server computers, client computers, and other devices not shown. Client devices 110 connect to network 102 utilizing at least one of wired, optical fiber, or wireless connections.

Program code located in network data processing system 100 can be stored on a computer-recordable storage medium and downloaded to a data processing system or other device for use. For example, the program code can be stored on a computer-recordable storage medium on server computer 104 and downloaded to client devices 110 over network 102 for use on client devices 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented using a number of different types of networks. For example, network 102 can be comprised of at least one of the Internet, an intranet, a local area network (LAN), a metropolitan area network (MAN), or a wide area network (WAN). FIG. 1 is intended as an example, and not as an architectural limitation for the different illustrative embodiments.

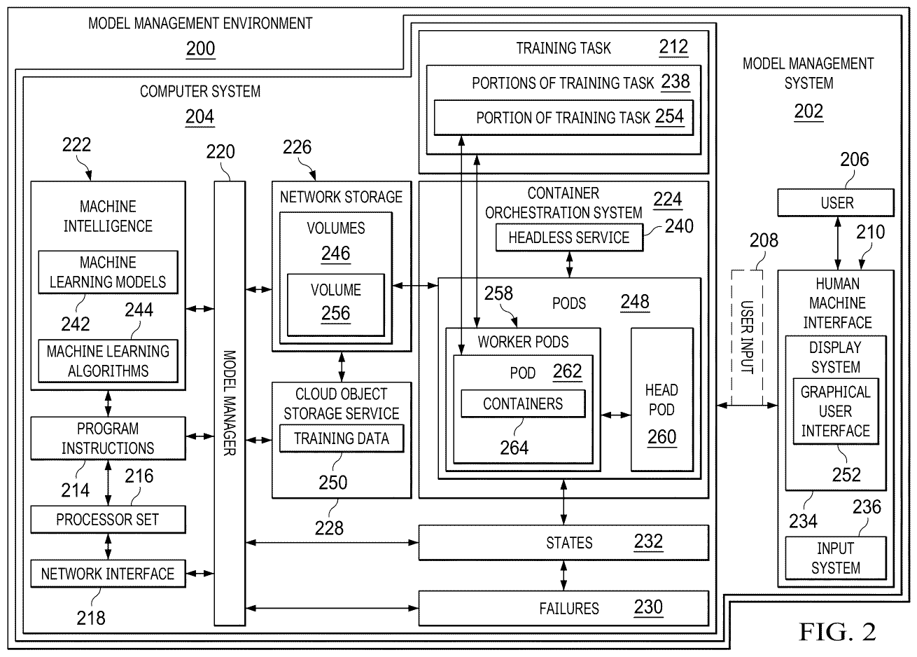

With reference now to FIG. 2, an illustration of a block diagram of a model management environment is depicted in accordance with an illustrative embodiment. In this illustrative example, model management environment 200 includes components that can be implemented in hardware such as the hardware shown in network data processing system 100 in FIG. 1.

In this illustrative example, model management system 202 in model management environment 200 enables training and utilization of machine learning models 242 in machine intelligence 222 by performing training task 212 using container orchestration system 224. In this illustrative example, model management system 202 includes computer system 204 which includes model manager 220. Model manager 220 is located in computer system 204.

Model manager 220 can be implemented in software, hardware, firmware, or a combination thereof. When software is used, the operations performed by model manager 220 can be implemented in program instructions configured to run on hardware, such as a processor unit. When firmware is used, the operations performed by model manager 220 can be implemented in program instructions and data and stored in persistent memory to run on a processor unit. When hardware is employed, the hardware can include circuits that operate to perform the operations in model manager 220.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C,” may include item A, item A and item B, or item B. This example also may include item A, item B, and item C, or item B and item C. Of course, any combination of these items can be present. In some illustrative examples, “at least one of” can be, for example, without limitation, two of item A; one of item B; and ten of item C; four of item B and seven of item C; or other suitable combinations.

Computer system 204 is a physical hardware system and includes one or more data processing systems. When more than one data processing system is present in computer system 204, those data processing systems are in communication with each other using a communications medium. The communications medium can be a network. The data processing systems can be selected from at least one of a computer, a server computer, a tablet computer, or some other suitable data processing system.

As depicted, computer system 204 includes processor set 216 that is capable of executing program instructions 214 implementing processes in the illustrative examples. In other words, program instructions 214 are computer-readable program instructions.

As used herein, a processor unit in processor set 216 is a hardware device and is comprised of hardware circuits such as those on an integrated circuit that respond to and process instructions and program code that operate a computer. A processor unit can be implemented using processor set 216 in FIG. 2. When processor set 216 executes program instructions 214 for a process, processor set 216 can be one or more processor units that are in the same computer or in different computers. In other words, the process can be distributed between processor set 216 on the same or different computers in computer system 204.

Further, processor set 216 can be of the same type or different types of processor units. For example, processor set 216 can be selected from at least one of a single core processor, a dual-core processor, a multi-processor core, a general-purpose central processing unit (CPU), a graphics processing unit (GPU), a digital signal processor (DSP), or some other type of processor unit.

As depicted, computer system 204 includes machine intelligence 222. Machine intelligence 222 can include machine learning models 242 and machine learning algorithms 244. Machine learning models 242 is a branch of artificial intelligence (AI) that enables computers to detect patterns and improve performance without direct programming commands. Rather than relying on direct input commands to complete a task, machine learning models 242 relies on input data. The data is fed into the machine, one of machine learning algorithms 244 is selected, parameters for the data are configured, and the machine is instructed to find patterns in the input data through optimization algorithms. The data model formed from analyzing the data is then used to predict future values.

Machine intelligence 222 is continuously refined over time through trial and error. Equivalence of assets or products can be effectively performed by supervised machine learning so that products or assets that do not match descriptively can nevertheless be matched. Over time, the data model from machine learning can provide a greater degree of flexibility in matching machine intelligence 222.

Machine intelligence 222 can be implemented using one or more systems such as an artificial intelligence system, a neural network, a generative neural network, a Bayesian network, an expert system, a fuzzy logic system, a genetic algorithm, or other suitable types of systems. Machine learning models 242 and machine learning algorithms 244 may make computer system 204 a special purpose computer for training and utilizing machine learning models using container orchestration system 224.

As depicted, machine learning models 242 involves using machine learning algorithms 244 to build computation models based on samples of data. The samples of data used for training are referred to as training data or training datasets. In this illustrative example, the training data or training datasets can also include synthetic data specifically generated for training machine learning models 242. Machine intelligence 222 can make predictions without being explicitly programmed to make these predictions. Machine intelligence 222 can be used for training and retraining computation models for a number of different types of applications. These applications include, for example, medicine, financial services, healthcare, speech recognition, computer vision, or other types of applications. In this illustrative example, models in machine learning models 242 can be trained by performing training task 212 using container orchestration system 224.

In this illustrative example, training of machine learning models 242 involves using computing resources from processor units (processing units) in processor set 216. In this illustrative example, processor units that are used to perform training of machine learning models 242 can communicate with each other through network interface 218, which provides direct access to memory of the processor units and direct communications between the processor units.

In this illustrative example, network interface 218 can be implemented using AWS Elastic Fabric Adapter (EFA)®. EFA functions as an elastic network adapter, augmenting conventional capabilities by enabling applications to communicate directly with their network interface hardware and bypassing the operating system.

In this illustrative example, machine learning models 242 can include a number of models. For example, machine learning models 242 can include a deep learning model such as a large language model. In this illustrative example, large language model is a type of machine learning model designed to understand, generate, and manipulate human language. In this illustrative example, machine learning models 242 can also include machine learning models for automatic speech recognition and machine learning models for visual document understanding.

In this illustrative example, machine learning algorithms 244 can include supervised machine learning algorithms, semi-supervised machine learning algorithms, reinforcement learning algorithms, and unsupervised machine learning algorithms. In this illustrative example, above mentioned machine learning algorithms 244 can train machine learning models 242 using data containing both the inputs and desired outputs. Examples of machine learning algorithms 244 include XGBoost, K-means clustering, and random forest. In addition, machine learning algorithms 244 can also include other algorithms. For example, those algorithms can include Supervised Fine Tuning, Continued Pre Training, Direct Performance Optimization, and Connectionist Temporal Classification.

In this illustrative example, model manager 220 creates headless service 240 and a number of pods 248 for container orchestration system 224. Container orchestration system 224 is a software platform that automates the deployment, management, scaling, and networking of containerized applications. In this illustrative example, container orchestration system 224 can be Kubernetes® platform.

In this illustrative example, the number of pods 248 are smallest deployable units that represent instances of running applications. Each pod in the number of pods 248 contains a number of containers that share the same network namespace, storage volumes, and other resources. For example, pod 262 in the number of pods 248 can have a number of containers 264 for performing tasks.

As depicted, containers such as the number of containers 264 are lightweight, standalone executable packages that include applications and all dependencies such as libraries, binaries, and runtime environments for the applications. As a result, containers can be packaged and run applications consistently across different environments.

In addition, headless service 240 is a type of service that does not use ClusterIP to load balance requests but instead provides direct access to the underlying pods. In this illustrative example, headless service 240 ensures that container orchestration system 224 does not allocate a virtual IP address for the service. Instead, the actual pod Internet Protocol (IP) addresses are returned to directly connect clients to a specific pod in the number of pods 248.

In this illustrative example, headless service 240 and the number of pods 248 can be created using a workflow orchestration tool. In this example, the workflow orchestration tool is a software that automates, schedules, and manages execution of complex workflows to ensure tasks are executed in the correct order. In this illustrative example, the workflow orchestration tool can be implemented using Apache Airflow®, which allows users to define workflows as Directed Acyclic Graphs (DAGs). In this illustrative example, Apache Airflow® can also be used in combination with a configurable tool such that Apache Airflow® can be configured to manage pod lifetime for the number of pods 248 instead of control plane from container orchestration system 224.

In this illustrative example, the workflow orchestration tool serves as a more adept resource controller that is specifically tailored for orchestrating batch-oriented machine learning workloads.

In this illustrative example, the number of pods 248 in container orchestration system 224 can be categorized into worker pods 258 and head pod 260. Head pod 260 serves as the coordinating unit that manages worker pods 258. For example, head pod 260 can be configured to handle scheduling, job distribution, aggregation of results, and facilitate communications between worker pods 258. In this illustrative example, head pod 260 can be selected in a number of ways. For example, head pod 260 be selected by designating the first pod from the number of pods 248 for performing portions of training task 238 from training task 212. In this illustrative example, all pods in the number of pods 248 may have the same computing resources.

On the other hand, worker pods 258 are pods responsible for processing workloads or executing tasks such as training task 212. In this illustrative example, each worker pod from worker pods 258 works independently but is subject to the coordination from head pod 260.

In this illustrative example, model manager 220 transfers a set of training data 250 from cloud object storage service 228 to the number of pods 248 in container orchestration system 224. Cloud object storage service 228 is a storage service that allows users to store and retrieve large amounts of unstructured data such as documents, images, videos, and logs. Unlike traditional file system, cloud object storage service 228 organizes data into objects, each containing metadata and a unique identifier for efficient use for cloud-based applications. In this illustrative example, cloud object storage service 228 can be implemented using Amazon S3®.

In this illustrative example, model manager 220 can use container orchestration system 224 to divide training task 212 into portions of training task 238 such that each pod from the number of pods 248 can handle a portion of training task from training task 212. For example, pod 262 from worker pods 258 can be assigned to perform portion of training task 254 from portions of training task 238. In other words, the number of containers 264 in pod 262 are responsible for performing portion of training task 254 for completing training task 212. In this illustrative example, it should be understood that head pod 260 is also responsible for performing a portion of training task from training task 212. In this illustrative example, the number of pods 248 scales with the size of data and machine learning models.

In this illustrative example, cloud object storage service 228 can work in combination with network storage 226 such that a single volume from volumes 246 in network storage 226 can be mounted to each pod from the number of pods 248. For example, volume 256 from volumes 246 can be mounted to pod 262 from worker pods 258. In this illustrative example, the mountings of volumes of the network storage allows the set of training data 250 from cloud object storage service 228 to be streamed into individual subdirectories for each pod from the number of pods 248. In this illustrative example, network storage 226 can be implemented using Amazon Elastic File System (EFS)®.

The implementation using Amazon Elastic File System (EFS)® prioritizes minimizing cost and eliminates downloading the entirety of the set of training data 250 at once. In this illustrative example, the set of training data 250 is streamed directly from cloud object storage service 228 as needed is simply more effective. In this illustrative example, streaming means fetching data directly from cloud object storage service 228 and buffering the data in memory, then caching it on a disk during the performance of training task 212. In an alternative illustrative example, each pod in the number of pods 248 needs to stream only the relevant shards for its training if training data 250 is sharded.

In this illustrative example, use of network storage 226 provides various advantages. For example, network storage 226 provides isolation of different training data for each training run. In addition, network storage 226 prevents deadlocks during read/write operations by ensuring that each node within a training run has isolated access to the training data. Further, network storage 226 provides facilitation of distributing model checkpoints across nodes by storing the model checkpoints on cloud object storage service 228. In this illustrative example, nodes are physical or virtual machines within container orchestration system 224 that runs and supports containerized applications. In other words, the nodes provide necessary GPU, CPU, memory, storage, and networking resources for the number of pods 248 for performing training task 212. Moreover, network storage 226 eliminates initial data download time by streaming data directly.

As a result, the number of pods 248 can work in parallel in a distributed manner to complete training task 212 more efficiently by utilizing cloud object storage service 228 and the number of pods 248 and headless service 240 through container orchestration system 224.

In addition, model manager 220 can also monitor states 232 for the number of pods 248 using container orchestration system 224. States 232 are representations of status for the number of pods 248 during their lifecycles. In this illustrative example, information associated with states 232 for the number of pods 248 can be constantly logged in computer system 204 as training task 212 is performed by the number of pods 248. In addition, checkpoints for training task 212 can also be saved based on logged states 232 in computer system 204.

In this illustrative example, states 232 for the number of pods 248 can be determined using a number of performance metrics. For example, the number of performance metrics can include loss, accuracy, CPU/GPU load, power consumption, memory, or any information related to the number of pods 248 during performance of training task 212.

In this illustrative example, model manager 220 periodically identifies whether failures 230 are present for the number of pods 248. Failures 230 are errors or issues that are associated with at least one pod from the number of pods 248 during the performance of training task 212. In this illustrative example, failures 230 can be any issues or errors that cause disruptions of training task 212 for machine learning models 242. For example, failures 230 can arise due to resource constraints, misconfigurations, network issues, or application errors. In this illustrative example, failures 230 can be software related or hardware related.

In this illustrative example, model manager 220 can use container orchestration system 224 to recover progress of training task 212 if failures 230 can be identified. In this illustrative example, progress of training task 212 can be recovered using checkpoints and states 232 as logged in computer system 204.

In an alternative illustrative example, software related issues from failures 230 can be resolved by restarting training task 212 from the most recent checkpoint, while hardware related issues from failures 230 can be resolved by solution that involves rebooting affected nodes or replacing faulty nodes in container orchestration system 224. It should be understood that the probability for occurrence of failures 230 can increase in a number of ways. For example, probability for occurrence of failures 230 increases as number of pods and associated computer nodes increases. In a similar fashion, probability for occurrence of failures 230 also increases as training of machine learning models 242 takes longer.

In this illustrative example, users such as user 206 can interact with computer system 204 through user inputs to computer system 204. For example, computer system 204 can receive user input 208 that includes creation of headless service 240 and the number of pods 248.

In this illustrative example, user input 208 can be generated by user 206 using human machine interface (HMI) 210. As depicted, human machine interface 210 includes display system 234 and input system 236. Display system 234 is a physical hardware system and includes one or more display devices on which graphical user interface 252 can be displayed. The display devices can include at least one of a light emitting diode (LED) display, an organic light emitting diode (OLED) display, a computer monitor, a projector, a flat panel display, a heads-up display (HUD), a head-mounted display (HMD), smart glasses, augmented reality glasses, or some other suitable device that can output information for the visual presentation of information.

In this example, user 206 is a person that can interact with graphical user interface 252 through user input 208 generated by input system 236. Input system 236 is a physical hardware system and can be selected from at least one of a mouse, a keyboard, a touch pad, a trackball, a touchscreen, a stylus, a motion sensing input device, a gesture detection device, a data glove, a cyber glove, a haptic feedback device, or some other suitable type of input device. For example, user 206 can view states 232 and failures 230 for the number of pods 248 through graphical user interface 252 in display system 234. In addition, user 206 can provide user input 208 through graphical user interface 252.

In an alternative illustrative example, model manager 220 can also facilitate seamless communication between processor units in processor set 216 using NCCL and NCCL tests. In this example, a StatefulSet can be deployed, where each pod from the number of pods 248 contains a single container that requests maximum resources from its node, and starts an SSH server to wait for connections. Subsequently, a separate launcher job can be initiated to launch the NCCL tests. The launcher node can discover worker pods 258 through a host file containing the node hostnames established by the StatefulSet and connects to them using a pre-configured password-less SSH connection.

However, it is still needed to devise another multi-node training architecture because some deep learning frameworks have different launching processes, such as the widely-used framework PyTorch®, and its launcher Torchrun. Torchrun requires that each node individually executes the launcher command, which eliminates the need for the separate launcher job and the password-less SSH setup.

In this illustrative example, the approach mentioned above introduces a new technical difficulty. Every time training is completed, the StatefulSet restarts the containers and launches training again. In this illustrative example, indexed jobs can be used to ensure that once training is over, the number of pods 248 are terminated. Indexed jobs are type of job where each task within the job is assigned a unique index number that allows parallel execution with specific indexing. In other words, each portion of training task from portions of training task 238 is assigned with a unique index number that allows parallel execution of portions of training task 238 using the number of pods 248.

Nevertheless, one trade-off of using indexed jobs is that currently there is no way to mount the same Persistent Volume Claim (PVC) to all pods in an indexed job, which can be resolved by the use of workflow orchestration tools such as Airflow® as described above.

In one illustrative example, one or more solutions are present that overcome a problem with training machine learning models in a distributed manner using container orchestration systems, especially for training machine learning models in a distributed manner using indexed jobs in a container orchestration system. As a result, one or more technical solutions may provide an ability to increase efficiency and resource utilization for training machine learning models in computer system 204.

In the illustrative example, computer system 204 can be configured to perform at least one of the steps, operations, or actions described in the different illustrative examples using software, hardware, firmware, or a combination thereof. As a result, computer system 204 operates as a special purpose computer system in which model manager 220 in computer system 204 enables efficient utilization of computing resources during training of machine learning models, especially for training machine learning models in a distributed manner using indexed jobs in a container orchestration system. In particular, model manager 220 transforms computer system 204 into a special purpose computer system as compared to currently available general computer systems that do not have model manager 220.

In the illustrative example, the use of model manager 220 in computer system 204 integrates processes into a practical application for model construction using architecture that is designed for training machine learning models in a distributed manner using indexed jobs in a container orchestration system. Model manager 220 improves efficiency of training machine learning models in a container orchestration system such that performance of computer system 204 can be increased. In other words, model manager 220 in computer system 204 is directed to a practical application of processes integrated into model manager 220 in computer system 204 that enables training of machine learning models using container orchestration system in an efficient manner.

The illustration of model management environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

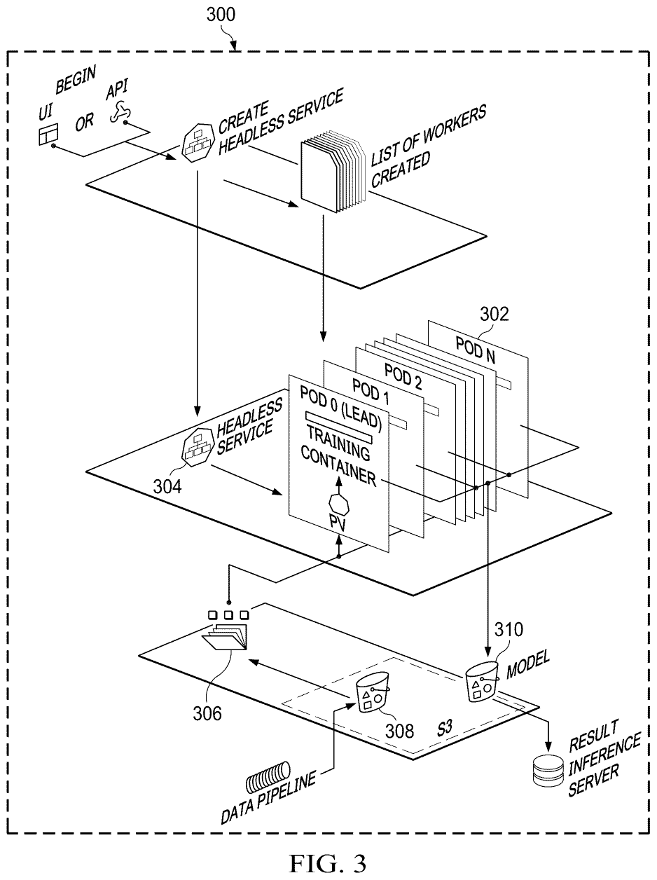

FIG. 3 depicts an exemplary architecture for training machine learning models in accordance with an illustrative embodiment. In this illustrative example, architecture 300 can be implemented in computer system 204 using model manager 220 in FIG. 2.

In this illustrative example, architecture 300 can be set up by creating headless service 304 with a number of pods 302 on a container orchestration system such as Kubernetes®. As depicted, headless service 304 and the number of pods 302 can be created using a workflow orchestration tool such as Airflow® through a user interface (UI) or an application programming interface (API). In this illustrative example, headless service 304 and the number of pods 302 can be examples of headless service 240 and the number of pods 248 in FIG. 2.

As depicted, a machine learning model can be trained in a distributed manner using the number of pods 302 from the container orchestration system. In this illustrative example, each pod from the number of pods 302 handles a portion of training such that the training for the machine learning model can be performed more efficiently.

As depicted in architecture 300 in FIG. 3, training data can be input directly from cloud object storage service 308 through network storage 306. In this illustrative example, a single volume of network storage 306 is mounted to each pod from the number of pods 302. In this illustrative example, cloud object storage service 308 and network storage 306 can be examples of cloud object storage service 228 and network storage 226 in FIG. 2.

As a result, machine learning model 310 is generated by the container orchestration system that performs the training by leverages headless service 304 using the number of pods 302, cloud object storage service 308 and network storage 306. In this illustrative example, machine learning model 310 can be an example of machine learning models 242 in FIG. 2.

The illustration of architecture 300 in FIG. 3 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, architecture 300 can be implemented using other components that serve identical or similar functions as the components shown in architecture 300.

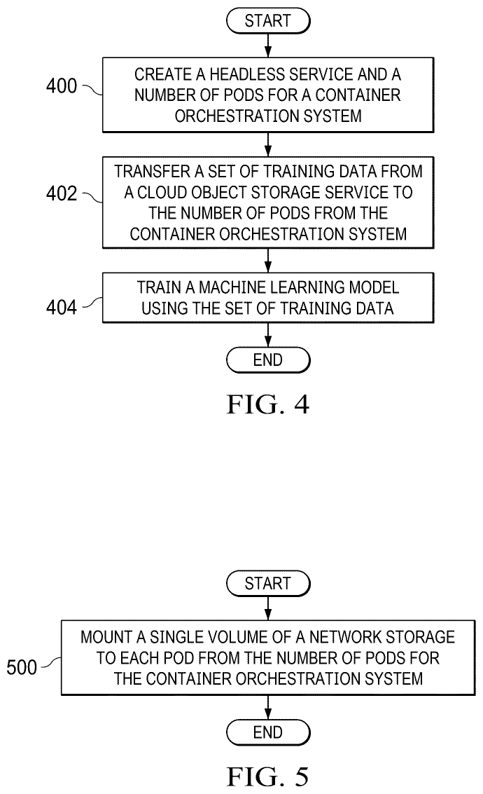

With reference now to FIG. 4, a flowchart illustrating a process for training machine learning models is shown in accordance with an illustrative embodiment. The process in FIG. 4 can be implemented in hardware, software, or both. When implemented in software, the process can take the form of program instructions that are run by one of more processor units located in one or more hardware devices in one or more computer systems. For example, the process can be implemented in model manager 220 in computer system 204 in FIG. 2.

The process begins by creating a headless service and a number of pods for a container orchestration system (step 400). In step 400, each pod from the number of pods includes a number of containers for performing tasks. The process transfers a set of training data from a cloud object storage service to the number of pods from the container orchestration system (step 402).

The process trains a machine learning model using the set of training data (step 404). In step 404, the machine learning model is trained in a distributed manner using the headless service and the number of pods for the container orchestration system. In addition, the container orchestration system divides training task for the machine learning model into a number of portions of the training task and each pod from the number of pods performs a portion of the training task to train the machine learning model. The process terminates thereafter.

With reference now to FIG. 5, a flowchart illustrating a process for training a machine learning model is shown in accordance with an illustrative embodiment. The process in this flowchart is an example of an implementation of step 404 in FIG. 4.

The process begins by mounting a single volume of a network storage to each pod from the number of pods for the container orchestration system (step 500). The process terminates thereafter.

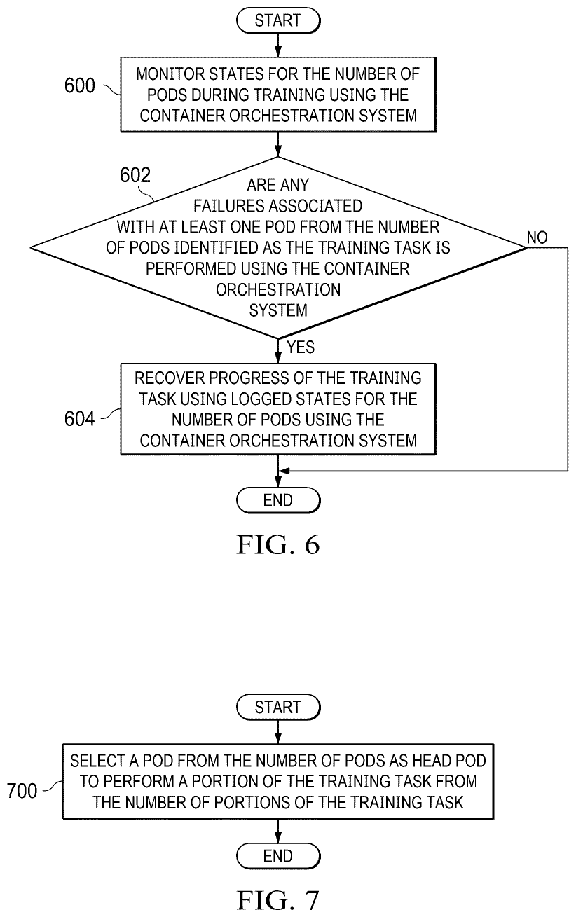

With reference now to FIG. 6, a flowchart illustrating a process for recovering progress for the training task of a machine learning model is shown in accordance with an illustrative embodiment. The process in this figure is an example of an additional step that can be performed with the steps in FIG. 4.

The process begins by monitoring states for the number of pods during training using the container orchestration system (step 600). In this step, the states for the number of pods are constantly logged as the training task is performed.

The process periodically identifies whether any failures are associated with at least one pod from the number of pods as the training task is performed using the container orchestration system (step 602). In step 602, the failures associated with the at least one pod from the number of pods cause disruptions of the training task for the machine learning model.

In response to identifying that no failures are associated with the at least one pod from the number of pods, the process terminates thereafter.

With reference to step 602 again, if failures associated with at least one pod from the number of pods are identified, the process recovers progress of the training task using logged states for the number of pods using the container orchestration system (step 604). The process terminates thereafter.

With reference now to FIG. 7, a flowchart illustrating a process for selecting a head pod to perform a portion of the training task is shown in accordance with an illustrative embodiment. The process in this figure is an example of an additional step that can be performed with the steps in FIG. 4.

The process begins by selecting a pod from the number of pods as head pod to perform a portion of the training task from the number of portions of the training task (step 700). In this step, the head pod has computing resources for performing the portion of the training task from the number of portions of the training task. In addition, the head pod facilitates communications and assigns the number of portions of the training task for worker pods from the number of pods. The process terminates thereafter.

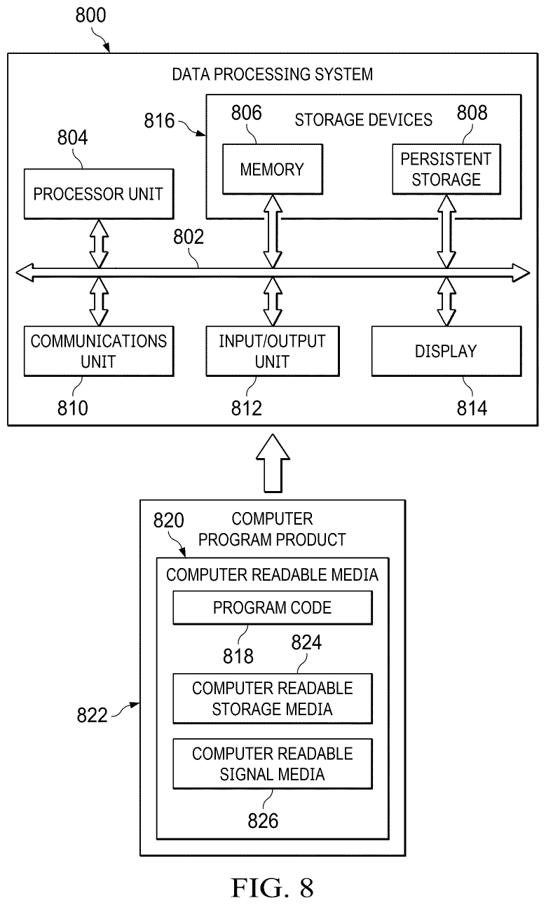

With reference now to FIG. 8, an illustration of a block diagram of a data processing system is depicted in accordance with an illustrative embodiment. Data processing system 800 may be used to implement server computer 104 and server computer 106 and client devices 110 in FIG. 1, as well as computer system 204 in FIG. 2. In this illustrative example, data processing system 800 includes communications framework 802, which provides communications between processor unit 804, memory 806, persistent storage 808, communications unit 810, input/output unit 812, and display 814. In this example, communications framework 802 may take the form of a bus system.

Processor unit 804 serves to execute instructions for software that may be loaded into memory 806. Processor unit 804 may be a number of processors, a multi-processor core, or some other type of processor, depending on the particular implementation. In an embodiment, processor unit 804 comprises one or more conventional general-purpose central processing units (CPUs). In an alternate embodiment, processor unit 804 comprises one or more graphical processing units (GPUs).

Memory 806 and persistent storage 808 are examples of storage devices 816. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 816 may also be referred to as computer-readable storage devices in these illustrative examples. Memory 806, in these examples, may be, for example, a random access memory or any other suitable volatile or non-volatile storage device. Persistent storage 808 may take various forms, depending on the particular implementation.

For example, persistent storage 808 may contain one or more components or devices. For example, persistent storage 808 may be a hard drive, a flash memory, a rewritable optical disk, a rewritable magnetic tape, or some combination of the above. The media used by persistent storage 808 also may be removable. For example, a removable hard drive may be used for persistent storage 808. Communications unit 810, in these illustrative examples, provides for communications with other data processing systems or devices. In these illustrative examples, communications unit 810 is a network interface card.

Input/output unit 812 allows for input and output of data with other devices that may be connected to data processing system 800. For example, input/output unit 812 may provide a connection for user input through at least one of a keyboard, a mouse, or some other suitable input device. Further, input/output unit 812 may send output to a printer. Display 814 provides a mechanism to display information to a user.

Instructions for at least one of the operating system, applications, or programs may be located in storage devices 816, which are in communication with processor unit 804 through communications framework 802. The processes of the different embodiments may be performed by processor unit 804 using computer-implemented instructions, which may be located in a memory, such as memory 806.

These instructions are referred to as program code, computer-usable program code, or computer-readable program code that may be read and executed by a processor in processor unit 804. The program code in the different embodiments may be embodied on different physical or computer-readable storage media, such as memory 806 or persistent storage 808.

Program code 818 is located in a functional form on computer readable media 820 that is selectively removable and may be loaded onto or transferred to data processing system 800 for execution by processor unit 804. Program code 818 and computer readable media 820 form computer program product 822 in these illustrative examples. In one example, computer readable media 820 may be computer readable storage media 824 or computer readable signal media 826.

In these illustrative examples, computer readable storage media 824 is a physical or tangible storage device used to store program code 818 rather than a medium that propagates or transmits program code 818. Computer readable storage media 824, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program code 818 may be transferred to data processing system 800 using computer readable signal media 826. Computer readable signal media 826 may be, for example, a propagated data signal containing program code 818. For example, computer readable signal media 826 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 800 are not meant to provide architectural limitations to the manner in which different embodiments may be implemented. The different illustrative embodiments may be implemented in a data processing system including components in addition to or in place of those illustrated for data processing system 800. Other components shown in FIG. 8 can be varied from the illustrative examples shown. The different embodiments may be implemented using any hardware device or system capable of running program code 818.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams may be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

The different illustrative examples describe components that perform actions or operations. In an illustrative embodiment, a component may be configured to perform the action or operation described. For example, the component may have a configuration or design for a structure that provides the component with an ability to perform the action or operation that is described in the illustrative examples as being performed by the component.

Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A computer-implemented method comprising:
creating, by a processor set, a headless service and a number of pods for a container orchestration system, wherein each pod from the number of pods comprises a number of containers for performing tasks;
transferring, by the processor set, a set of training data from a cloud object storage service to the number of pods from the container orchestration system; and
training, by the processor set, a machine learning model using the set of training data, wherein the machine learning model is trained in a distributed manner using the headless service and the number of pods for the container orchestration system, and wherein the container orchestration system divides training task for the machine learning model into a number of portions of the training task and each pod from the number of pods performs a portion of the training task to train the machine learning model.

2. The computer-implemented method of claim 1, wherein training, by a processor set, a machine learning model using the set of training data comprises:
mounting, by the processor set, a single volume of a network storage to each pod from the number of pods for the container orchestration system.

3. The computer-implemented method of claim 2, wherein the mountings of volumes of the network storage allows the set of training data from the cloud object storage service to be streamed into individual subdirectories for each pod from the number of pods.

4. The computer-implemented method of claim 1, further comprising:
monitoring, by the processor set using the container orchestration system, states for the number of pods during training, wherein the states for the number of pods are constantly logged as the training task is performed;
periodically identifying, by the processor set using the container orchestration system, whether any failures are associated with at least one pod from the number of pods as the training task is performed, wherein the failures associated with the at least one pod from the number of pods cause disruptions of the training task for the machine learning model; and
in response to identifying the failures associated with the at least one pod from the number of pods, recovering, by the processor set using the container orchestration system, progress of the training task using logged states for the number of pods.

5. The computer-implemented method of claim 1, further comprising:
selecting, by the processor set, a pod from the number of pods as head pod to perform a portion of the training task from the number of portions of the training task, wherein the head pod has computing resources for performing the portion of the training task from the number of portions of the training task, and wherein the head pod facilitates communications and assigns the number of portions of the training task for worker pods from the number of pods.

6. The computer-implemented method of claim 1, wherein the headless service and the number of pods for the container orchestration system is created by a workflow orchestration tool.

7. The computer-implemented method of claim 1, wherein processing units for training the machine learning model communicate with each other through a network interface, wherein the network interface provides direct access to memory of the processing units and direct communications between the processing units.

8. A computer system, comprising:
a processor set;
a set of one or more computer-readable storage media; and
program instructions stored on the set of one or more computer-readable storage media to cause the processor set to perform operations comprising:
creating a headless service and a number of pods for a container orchestration system, wherein each pod from the number of pods comprises a number of containers for performing tasks;
transferring a set of training data from a cloud object storage service to the number of pods from the container orchestration system; and
training a machine learning model using the set of training data, wherein the machine learning model is trained in a distributed manner using the headless service and the number of pods for the container orchestration system, and wherein the container orchestration system divides training task for the machine learning model into a number of portions of the training task and each pod from the number of pods performs a portion of the training task to train the machine learning model.

9. The computer system of claim 8, wherein training a machine learning model using the set of training data comprises:
mounting a single volume of a network storage to each pod from the number of pods for the container orchestration system.

10. The computer system of claim 9, wherein the mountings of volumes of the network storage allows the set of training data from the cloud object storage service to be streamed into individual subdirectories for each pod from the number of pods.

11. The computer system of claim 8, wherein the operations further comprise:
monitoring states for the number of pods during training using the container orchestration system, wherein the states for the number of pods are constantly logged as the training task is performed;
periodically identifying whether any failures are associated with at least one pod from the number of pods as the training task is performed using the container orchestration system, wherein the failures associated with the at least one pod from the number of pods cause disruptions of the training task for the machine learning model; and
in response to identifying the failures associated with the at least one pod from the number of pods, recovering progress of the training task using logged states for the number of pods using the container orchestration system.

12. The computer system of claim 8, wherein the operations further comprise:
selecting a pod from the number of pods as head pod to perform a portion of the training task from the number of portions of the training task, wherein the head pod has computing resources for performing the portion of the training task from the number of portions of the training task, and wherein the head pod facilitates communications and assigns the number of portions of the training task for worker pods from the number of pods.

13. The computer system of claim 8, wherein the headless service and the number of pods for the container orchestration system is created by a workflow orchestration tool.

14. The computer system of claim 8, wherein processing units for training the machine learning model communicate with each other through a network interface, wherein the network interface provides direct access to memory of the processing units and direct communications between the processing units.

15. A computer program product, comprising:
a set of one or more computer-readable storage media;
program instructions stored in the set of one or more computer-readable storage media to perform operations comprising:
creating, by a processor set, a headless service and a number of pods for a container orchestration system, wherein each pod from the number of pods comprises a number of containers for performing tasks;
transferring, by the processor set, a set of training data from a cloud object storage service to the number of pods from the container orchestration system;
and training, by the processor set, a machine learning model using the set of training data, wherein the machine learning model is trained in a distributed manner using the headless service and the number of pods for the container orchestration system, and wherein the container orchestration system divides training task for the machine learning model into a number of portions of the training task and each pod from the number of pods performs a portion of the training task to train the machine learning model.

16. The computer program product of claim 15, wherein training, by a processor set, a machine learning model using the set of training data comprises:
mounting, by the processor set, a single volume of a network storage to each pod from the number of pods for the container orchestration system.

17. The computer program product of claim 16, wherein the mountings of volumes of the network storage allows the set of training data from the cloud object storage service to be streamed into individual subdirectories for each pod from the number of pods.

18. The computer program product of claim 15, wherein the operations further comprise:
monitoring, by the processor set using the container orchestration system, states for the number of pods during training, wherein the states for the number of pods are constantly logged as the training task is performed;
periodically identifying, by the processor set using the container orchestration system, whether any failures are associated with at least one pod from the number of pods as the training task is performed, wherein the failures associated with the at least one pod from the number of pods cause disruptions of the training task for the machine learning model; and
in response to identifying the failures associated with the at least one pod from the number of pods, recovering, by the processor set using the container orchestration system, progress of the training task using logged states for the number of pods.

19. The computer program product of claim 15, wherein the operations further comprise:
selecting, by the processor set, a pod from the number of pods as head pod to perform a portion of the training task from the number of portions of the training task, wherein the head pod has computing resources for performing the portion of the training task from the number of portions of the training task, and wherein the head pod facilitates communications and assigns the number of portions of the training task for worker pods from the number of pods.

20. The computer program product of claim 15, wherein processing units for training the machine learning model communicate with each other through a network interface, wherein the network interface provides direct access to memory of the processing units and direct communications between the processing units.
